(19) United States
(12) Patent Application Publication
(10) Pub. No.: US 2024/0289605 A1
(43) Pub. Date: Aug. 29, 2024

(54) Proxy Task Design Tools for Neural Architecture Search

(71) Applicant: Google LLC, Mountain View, CA (US)

(72) Inventors: Lav Rai, Sammamish, WA (US); Xiang Xu, Mountain View, CA (US); Yen-Min Hsu, Mountain View, CA (US); Bo Wu, Mountain View, CA (US); Daiyi Peng, Mountain View, CA (US)

(21) Appl. No.: 18/173,347

(22) Filed: Feb. 23, 2023

(51) Int. Cl. G06N 3/08

(52) U.S. Cl. CPC G06N 3/08

(57) ABSTRACT

Aspects of the disclosure are directed to proxy task design tools that automatically find proxy tasks, such as optimal proxy tasks, for neural architecture searches. The proxy task design tools can include one or more tools to search for an optimal proxy task having the lowest neural architecture search cost while meeting a minimum correlation requirement threshold after being provided with a proxy task search space definition. The proxy task design tools can further include one or more tools to select candidate models for computing correlation scores of proxy tasks as well as one or more tools to measure variance of a model. The proxy task design tools can minimize time and effort involved in designing the proxy task.

### BACKGROUND

Neural architecture search is a technique for automating the design of machine learning model architectures to meet desired goals, such as performance, with or without constraints, such as latency or power consumption requirements. To reduce the cost of searching thousands of architectures, neural architecture searches can involve the use of a proxy task. Proxy tasks run a significantly smaller version of the training involved in the neural architecture search. However, designing a proxy task can be time-consuming and challenging. Typically, proxy task choices are evaluated on their own, where large amounts of engineering time are spent validating and comparing these proxy task choices with no extra infrastructure support. Further, searching for an optimal proxy task can have repetitive training costs if not performed properly.

### BRIEF SUMMARY

Aspects of the disclosure are directed to proxy task design tools that automatically find proxy tasks for neural architecture searches. The proxy task design tools can include one or more tools to search for an optimal proxy task having the lowest neural architecture search cost while meeting a minimum correlation requirement threshold after being provided with a proxy task search space definition. The proxy task design tools can further include one or more tools to select candidate models for computing correlation scores of proxy tasks as well as one or more tools to measure variance of a candidate model. The proxy task design tools can minimize time and effort involved in designing the proxy task. The proxy task design tools can further save computing resources, such as memory usage or processing power, by finding proxy tasks that significantly reduce the cost of neural architecture searches.

An aspect of the disclosure provides for a method for automatically determining a proxy task for a neural architecture search. The method includes determining, by one or more processors, a plurality of correlation candidate models to evaluate each of a plurality of proxy task choices for the neural architecture search; generating, by the one or more processors, full-training scores for each of the plurality of correlation candidate models; generating, by the one or more processors, a correlation score for each of the plurality of proxy task choices using the plurality of correlation candidate models and the full-training scores; ranking, by the one or more processors, the plurality of proxy task choices based on the correlation scores and training time; selecting, by the one or more processors, a proxy task choice of the plurality of proxy task choices based on the ranking; and outputting, by the one or more processors, instructions associated with the selected proxy task choice.

In an example, the method further includes receiving, by the one or more processors, the plurality of proxy task choices for the neural architecture search.

In another example, determining the plurality of correlation candidate models further includes: randomly sampling a first plurality of models from a search space for the neural architecture search; training each of the first plurality of models for a first fraction of a full training time for the neural architecture search; and rejecting a first portion of the first plurality of models which do not add to a score distribution for one or more metrics among the first plurality of models, wherein a second plurality of models corresponds to the first portion subtracted from the first plurality of models. In yet another example, determining the plurality of correlation candidate models further includes: training each of the second plurality of models for a second fraction of the full training time for the neural architecture search, the second fraction being greater than the first fraction; and rejecting a second portion of the second plurality of models which do not add to a score distribution for the one or more metrics among the second plurality of models. In yet another example, determining the plurality of correlation candidate models further includes iteratively repeating training and rejecting of models until meeting a minimum amount of candidate models.

In yet another example, generating the correlation scores for each of the plurality of proxy task choices further includes: training each of the plurality of correlation candidate models; and during the training: monitoring one or more metrics and training time; and continuously computing the correlation score based on the full-training scores. In yet another example, generating the correlation scores for each of the plurality of proxy task choices further includes stopping the training once a threshold correlation score is obtained or at least one of a threshold amount of time or a threshold for the one or more metrics is exceeded. In yet another example, selecting the proxy task choice of the plurality of proxy tasks further includes selecting a proxy task choice that obtained the threshold correlation score within the shortest amount of time.

In yet another example, the method further includes randomly sampling, by the one or more processors, the search space to find a model for testing variance; running, by the one or more processors, training for a plurality of copies of the model for a reduced period of time; and measuring, by the one or more processors, at least one of a score variance or smoothness of the plurality of copies of the model. In yet another example, the method further includes determining, by the one or more processors, the score variance or smoothness is above a threshold; and outputting one or more instructions to lower the variance.

Another aspect of the disclosure provides for a system including: one or more processors; and one or more storage devices coupled to the one or more processors and storing instructions that, when executed by the one or more processors, cause the one or more processors to perform operations for automatically determining a proxy task for a neural architecture search. The operations include: determining a plurality of correlation candidate models to evaluate each of a plurality of proxy task choices for the neural architecture search; generating full-training scores for each of the plurality of correlation candidate models; generating a correlation score for each of the plurality of proxy task choices using the plurality of correlation candidate models and the full-training scores; ranking the plurality of proxy task choices based on the correlation scores and training time; selecting a proxy task choice of the plurality of proxy task choices based on the ranking; and outputting instructions associated with the selected proxy task choice.

In an example, determining the plurality of correlation candidate models further includes: randomly sampling a first plurality of models from a search space for the neural architecture search; training each of the first plurality of models for a first fraction of a full training time for the neural architecture search; and rejecting a first portion of the first plurality of models which do not add to a score distribution for one or more metrics among the first plurality of models, wherein a second plurality of models corresponds to the first portion subtracted from the first plurality of models. In another example, determining the plurality of correlation candidate models further includes iteratively repeating training and rejecting of models until meeting a minimum amount of candidate models.

In yet another example, generating the correlation scores for each of the plurality of proxy task choices further includes: training each of the plurality of correlation candidate models; during the training: monitoring one or more metrics and training time; and continuously computing the correlation score based on the full-training scores; and stopping the training once a threshold correlation score is obtained or at least one of a threshold amount of time or a threshold for the one or more metrics is exceeded. In yet another example, selecting the proxy task choice of the plurality of proxy tasks further includes selecting a proxy task choice that obtained the threshold correlation score within the shortest amount of time.

In yet another example, the operations further include: randomly sampling the search space to find a model for testing variance; running training for a plurality of copies of the model for a reduced period of time; and measuring at least one of a score variance or smoothness of the plurality of copies of the model.

Yet another aspect of the disclosure provides for a non-transitory computer readable medium for storing instructions that, when executed by one or more processors, cause the one or more processors to perform operations for automatically determining a proxy task for a neural architecture search. The operations include: determining a plurality of correlation candidate models to evaluate each of a plurality of proxy task choices for the neural architecture search; generating full-training scores for each of the plurality of correlation candidate models; generating a correlation score for each of the plurality of proxy task choices using the plurality of correlation candidate models and the full-training scores; ranking the plurality of proxy task choices based on the correlation scores and training time; selecting a proxy task choice of the plurality of proxy task choices based on the ranking; and outputting instructions associated with the selected proxy task choice.

In an example, determining the plurality of correlation candidate models further includes: randomly sampling a first plurality of models from a search space for the neural architecture search; training each of the first plurality of models for a first fraction of a full training time for the neural architecture search; rejecting a first portion of the first plurality of models which do not add to a score distribution for one or more metrics among the first plurality of models, wherein a second plurality of models corresponds to the first portion subtracted from the first plurality of models; and iteratively repeating training and rejecting of models until meeting a minimum amount of candidate models.

In another example, generating the correlation scores for each of the plurality of proxy task choices further includes: training each of the plurality of correlation candidate models; during the training: monitoring one or more metrics and training time; and continuously computing the correlation score based on the full-training scores; and stopping the training once a threshold correlation score is obtained or at least one of a threshold amount of time or a threshold for the one or more metrics is exceeded.

In yet another example, the operations further include: randomly sampling the search space to find a model for testing variance; running training for a plurality of copies of the model for a reduced period of time; and measuring at least one of a score variance or smoothness of the plurality of copies of the model.

### BRIEF DESCRIPTION OF THE DRAWINGS

FIG. 1 depicts a block diagram of an example proxy task design system according to aspects of the disclosure.

FIG. 2 depicts a block diagram of an example environment for implementing a proxy task design system according to aspects of the disclosure.

FIG. 3 depicts a block diagram illustrating one or more model architectures according to aspects of the disclosure.

FIG. 4 depicts a flow diagram of an example process for searching for a proxy task for a neural architecture search according to aspects of the disclosure.

FIG. 5 depicts a flow diagram of an example process for determining correlation candidate models to evaluate proxy task choices according to aspects of the disclosure.

FIG. 6 depicts a flow diagram of an example process for determining variance to evaluate proxy task choices according to aspects of the disclosure.

FIG. 7 depicts an example proxy task search space defined by discrete dimensions for training data and model scale according to aspects of the disclosure.

### DETAILED DESCRIPTION

Generally disclosed herein are implementations for design tools to automatically find proxy tasks for neural architecture searches, such as finding an optimal proxy task. Proxy tasks can reduce the cost of searching thousands of model architectures to find an architecture that meets desired goals, such as performance, with or without constraints, such as latency and/or power consumption requirements. The proxy task design tools can minimize time and effort involved in designing the proxy task, which can reduce engineering time requirements, reduce complexity and/or cost of running a neural architecture search, provide objective measures to compare different proxy task choices, and/or reduce support requirements for running a neural architecture search. The proxy task design tools can also save computing resources, such as memory usage or processing power, by finding proxy tasks that significantly reduce the cost of neural architecture searches.

During a neural architecture search, each model is trained and a score is reported back for comparing the models. Instead of training each model for longer periods of time, such as days, before reporting a score back, a proxy task representation can train each model for shorter periods of time, such as hours, before reporting the score back. As such, a proxy task can correspond to a low cost representation of a full-training job, requiring a significantly shorter period of training time, e.g., 1-2 hours instead of 1-2 days. Therefore, using proxy task training instead of full-training to compare different models, such as comparing different architectures, during a neural architecture search can reduce an overall search cost, such as by about 30-60 times. Creating a proxy task can involve using fewer training steps, using a sub-sampled training dataset, and/or using a scaled-down model.

Using fewer training steps can include reducing the number of training steps for a trainer and reporting a score back to a controller based on this partial training.

Using a sub-sampled training dataset can include either shuffling data randomly between shards of the training dataset and then choosing a smaller percentage or choosing a subset of the training dataset based on higher priority data samples, such as data samples that contribute more to the training performance. Using the sub-sampled training dataset to reduce training data can keep the search cost lower.

Using a scaled-down model can include scaling down a model relative to a baseline model for the proxy task. When scaling down the model, a tighter latency constraint can be used for the scaled-down model by scaling down the baseline model and measuring its latency to determine the tighter latency constraint. Using a scaled-down model can also include reducing an amount of augmentation and regularization compared to the baseline model. Latency gains for a scaled-down model can correspond to accuracy gain when scaling up the model. Examples of scaling down a model can include reducing model width, e.g., number of channels, reducing model depth, e.g., number of layers and block repeats, and/or reducing training data size without eliminating features.

The proxy task can include certain conditions to ensure returning a stable score and maintaining a quality of the neural architecture search. The proxy task design tools for finding the proxy task can consider these conditions. One condition can be correlation between the proxy task training and the full training. If a first model performs better than a second model during the proxy task training, then it can generally be assumed that the first model can perform better than the second model during the full training. To validate this assumption, correlation between the proxy task training scores and full training scores can be ranked using correlation candidate models. Proxy tasks can be ranked using a correlation score. Correlation candidate models should have rewards with enough variation to evaluate the rank correlation. For example, if the models in the user search space have scores varying in the range [0.2, 0.8], then the candidate models should have a range of at least 60-to-70% or above. The sampling in the range should also be spread-out, e.g., instead of 8 out of 10 models with a score of 0.2 and 2 models with score of 0.8, ideally the 10 candidate models should have a score of [0.2, 0.26, 0.32, 0.38, 0.44, 0.5, 0.56, 0.62, 0.68, 0.74]. If a search involves a constraint, such as latency, the constraint values can be correlated as well.

Another condition can be small variance in scores when the proxy task is repeated multiple times for the same model without any changes. A standard deviation-based measure, such as coefficient of variation, can be used to measure variance over reported scores over multiple runs. Large variance during training can be mitigated using cosine decay or stepwise learning rate decay as a learning-rate schedule rather than a constant learning rate. Exponential moving average or stochastic weighted averaging can further increase smoothness to decrease variance.

Yet another condition can be removing out-of-memory (OOM) and learning rate related errors. The architecture search space can generate models significantly larger than the baseline model, even when batch size is tuned for the baseline model. If an OOM error occurs, the batch size should be reduced. If a not-a-number (NAN) error occurs, the initial learning rate should be reduced, or gradient clipping should be added.

Proxy task design tools can include a modification to a trainer to allow for interacting with the proxy task design tools during an iterative process. Before a training cycle begins in a training loop, the proxy tasks design tools can determine whether training can be stopped early. After each training cycle in the training loop completes, new accuracy scores, training cycle begin and end steps, training cycle time, and total training steps can be reported to the proxy task design tools. The training cycle time should not include time for validation score evaluation. The trainer can compute validation scores frequently enough so that there is enough sample of the validation curve. If a constraint is used, the constraint can be updated after the constraint is computed. The model selection tool can require loading of a previous checkpoint for successive iterations, so a flag can be added to the trainer to enable reuse of a previous checkpoint. A metric identifier can correspond to accuracy and latency values, or any other metric reported by the trainer. If the trainer reward is different from accuracy, then an accuracy-only metric can also be reported back from the trainer.

Proxy task design tools can include a tool to measure variance for the trainer. For variance measurement, baseline training configuration can be modified to reduce the training steps to run for a short period of time, such as about 1-2 hours, and use cosine decay learning rate with setting its steps to be the same as the reduced training steps so that the learning rate can approach zero towards the end of the training. The search space can be sampled to find a model that does not generate any errors. Once such a model is found, a number of copies of the model, such as five, are run for the reduced training steps. Once training for these models is complete, a score variance and smoothness are measured. If the variance is too high, such as being above a threshold, exponential moving average or stochastic weighted averaging can be used to lower the variance.

Proxy tasks design tools can include a tool to select candidate models to compute correlation scores of proxy tasks. A number of correlation candidate models, such as about 10-20, can be found and their full-training scores can be computed to act as a reference for computing proxy task correlation scores for different proxy task options. The proxy task design tools can automatically and efficiently find the correlation candidate models and ensure they have a good score distribution for one or more metrics, such as accuracy, latency, memory usage, and/or power consumption. Accuracy can correspond to classification accuracy, mean-average-precision, or dice-scores, as examples. The proxy task design tools can randomly sample a plurality of models, such as 50, from a search space and train them for a fraction of the full training time, such as 1/50 of the full training time. As an example, the fraction of the full training time can be related to the amount of randomly sampled models. The proxy task design tools can reject a first portion of the plurality of models which do not add more to the distribution of the metrics. The proxy task design tools can then train the remaining models for a fraction of the full training time and then reject a second portion of the plurality of models which do not add more to the distribution of the metrics. The proxy task design tools can repeat this process until there is only a number of models with a good distribution left, such as 10-20. For example, as described earlier, if the models in the user search space have scores varying in the range [0.2, 0.8], then the candidate models should have a range of at least 60-to-70% or above. The sampling in the range should also be spread-out, e.g., instead of 8 out of 10 models with score of 0.2 and 2 models with score of 0.8, ideally the 10 candidate models should have a score of [0.2, 0.26, 0.32, 0.38, 0.44, 0.5, 0.56, 0.62, 0.68, 0.74]. A bad distribution would be [0.2, 0.2, 0.2, 0.2, 0.8] as the repeated scores add no new information. The proxy task design tool can train these last models to completion.

For model selection, the dataset partition can be the same as full training and trainer configuration can be the same as for baseline full training. At every iteration of model selection, the number of models decreases, and the training duration increases. The last iteration includes the final number of correlation candidate models with a good score distribution of the metrics. The final score range of the metrics for the correlation candidate models being better or close to the baseline model can indicate a good search space. If the final score range of the metrics is significantly worse than the baseline, the search space can be revisited.

The proxy task design tools can include a tool to search for the proxy task, such as an optimal proxy task. The optimal proxy task can have the lowest neural architecture search cost while meeting a minimum correlation requirement threshold after being provided with a proxy task search space definition. The optimal proxy task can save computing resources, such as memory usage or processing power, by optimally reducing the cost of a neural architecture search. The proxy task search space can be defined by discrete dimensions for training data and model scale.

Training step dimensions do not need to be included in the search space because the proxy task search can determine an optimal training step given a proxy task choice. For example, consider a proxy task choice of 50% training data, 25% model scale. The number of training steps can be initially set to the same amount as the full baseline training. When evaluating this proxy task, the proxy task search can launch training for the correlation-candidate models, monitor their current score for one or more metrics, such as accuracy and/or latency, and continuously compute a rank-correlation score using past full-training scores for the correlation-candidate models. The proxy-task search can stop the training once a desired correlation is obtained, such as 0.7, or can stop if the search cost quota is exceeded, such as greater than 4 hours per task. The proxy task search can evaluate each proxy task from the search space as a grid search and provide the best option. Each proxy task evaluation can include additional data, such as progress of accuracy correlation, p-values, median accuracy, and median training time over training steps. Each proxy task evaluation can also include a reason for stopping a search, such as training time limit exceeded, and the training step at which it stops. In response to determining the optimal proxy task, the number of training steps and the number of cosine decay steps can be set to the number of training steps of the optimal proxy task. A validation score evaluation can also be performed at the end of the training, to save multiple evaluation costs.

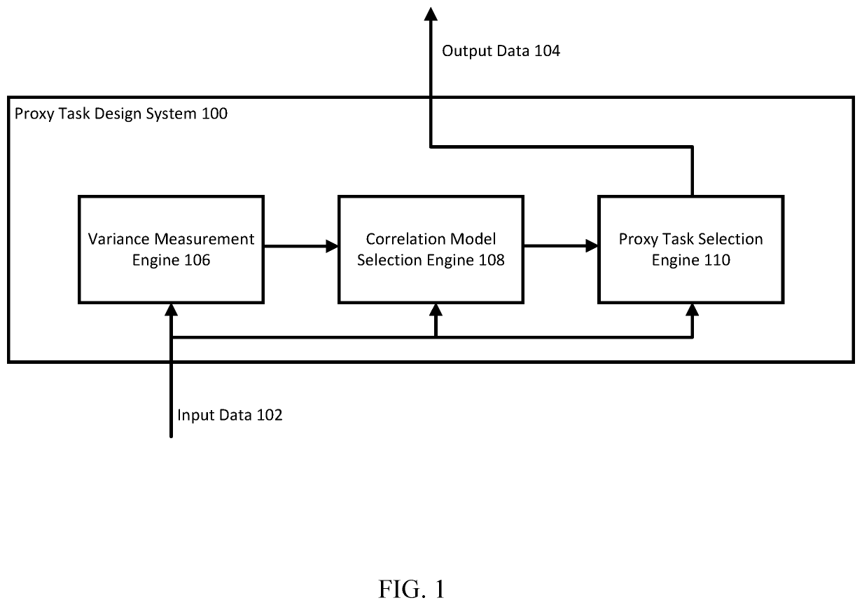

FIG. 1 depicts a block diagram of an example proxy task design system 100. The proxy task design system 100 can be configured to receive input data 102 via a user interface. For example, the proxy task design system 100 can receive the input data 102 as part of a call to an API exposing the proxy task design system 100. The proxy task design system 100 can be implemented on one or more computing devices. Input to the proxy task design system 100 can also be provided through a storage medium, including remote storage connected to the one or more computing devices over a network, or as input through a user interface on a client computing device coupled to the proxy task design system 100.

The input data 102 can include proxy task choices that define a proxy task search space. Proxy task choices can include reducing training steps, sub-sampling a training dataset, and/or scaling down one or more models.

Reducing the training steps can correspond to reducing the number of training steps for a trainer and reporting a score back based on a partial training with the reduced number of training steps. As an example, the training step reduction can be a percentage of the total training steps for full training, e.g., 25%, 50%, 75% of total training steps.

Sub-sampling the training dataset can correspond to shuffling data randomly between shards of a full training dataset and then selecting a smaller percentage of the full training dataset. Other sub-sampling techniques can also be implemented other than the random sampling, such as selecting a subset of the full training dataset based on high priority data samples, such as data samples that contribute more to the training performance. Sub-sampling the training dataset can keep the search cost lower by reducing training data.

Scaling down one or more models can correspond to reducing model architecture relative to a baseline model, such as reducing model width, e.g., number of channels, reducing model depth, e.g., number of layers and block repeats, and/or reducing training data size without eliminating features. Scaling down one or more models can also include tightening constraints, such as latency, memory usage, and/or power consumption. After the one or more models are scaled down, their constraint can be measured to determine the tighter constraint. As an example, latency gains for a scaled-down model can correspond to accuracy gains when scaling up the model. Scaling down one or more models can further include reducing an amount of augmentation and regularization compared to a baseline model.

The input data 102 can further include one or metrics for selecting a model. The one or more metrics can correspond to performance for the model and/or constraints for the model. Metrics corresponding to performance can include desired accuracy. Accuracy can correspond to classification accuracy, mean-average-precision, or dice-scores, as examples. Metrics corresponding to constraints can include latency, memory usage, and/or power consumption thresholds.

The one or more metrics can also correspond to characteristics for computing resources on which a model can be deployed. Computing resources can be housed in one or more datacenters or other physical locations hosting any of a variety of different types of hardware devices. Example types of hardware devices include central processing units (CPUs), graphics processing units (GPUs), edge or mobile computing devices, field programmable gate arrays (FPGAs) and various types of application-specific circuits (ASICs).

Some devices can be configured for hardware acceleration, which can include devices configured for efficiently performing certain types of operations. These hardware accelerators, which can for example include GPUs and tensor processing units (TPUs), can implement special features for hardware acceleration. Example features for hardware acceleration can include configuration to perform operations commonly associated with machine learning model execution, such as matrix multiplication. These special features can also include, as examples, matrix-multiply-and-accumulate units available in different types of GPUs, as well as matrix multiply units available in TPUs.

Characteristics for computing resources on which a model can be deployed can refer to one or more types and/or quantity of hardware accelerators or other computing devices. For example, the characteristics can define hardware characteristics and quantity for a particular type of hardware accelerator, including its processing capability, throughput, and memory capacity. As another example, the characteristics can specify computing resources for devices with less overall computational capacity than devices in a datacenter, such as mobile phones or wearable devices, e.g., headphones, earbuds, or smartwatches, on which a model is deployed. The proxy task design system 100 can automatically and efficiently find one or more models that can meet these metrics given the proxy task choices.

The input data 102 can also include training data for training one or more models. The training data can correspond to a machine learning task, such as a neural network task performed by a neural network. The training data can be split into a training set, a validation set, and/or a testing set. An example training/validation/testing split can be an 80/10/10 split. The model can be configured to receive any type of input data 102 to generate output data 104 for performing the machine learning task. As examples, the output data 104 can be any kind of score, classification, or regression output based on the input data 102. Correspondingly, the machine learning task can be a scoring, classification, and/or regression task for predicting some output given some input. These machine learning tasks can correspond to a variety of different applications in processing images, video, text, speech, or other types of data.

The training data can be in any form suitable for training a model, according to one of a variety of different learning techniques. Learning techniques for training a model can include supervised learning, unsupervised learning, and semi-supervised learning techniques. For example, the training data can include multiple training examples that can be received as input by a model. The training examples can be labeled with a desired output for the model when processing the labeled training examples. The label and the model output can be evaluated through a loss function to determine an error, which can be backpropagated through the model to update weights for the model. For example, if the machine learning task is a classification task, the training examples can be images labeled with one or more classes categorizing subjects depicted in the images. As another example, a supervised learning technique can be applied to calculate an error between outputs, with a ground-truth label of a training example processed by the model. Any of a variety of loss or error functions appropriate for the type of the task the model is being trained for can be utilized, such as cross-entropy loss for classification tasks, or mean square error for regression tasks. The gradient of the error with respect to the different weights of the candidate model on candidate hardware can be calculated, for example using a backpropagation algorithm, and the weights for the model can be updated. The model can be trained until stopping criteria are met, such as a number of iterations for training, a maximum period of time, a convergence, or when a minimum accuracy threshold is met.

From the input data 102, the proxy task design system 100 can be configured to output one or more results related to a proxy task, generated as output data 104. The output data 104 can include instructions associated with a proxy task choice, which can include an optimal model that obtained a threshold correlation score within the shortest amount of time. The output data 104 can also include instructions to lower variance or remove a not-a-number error. Instructions to lower variance can include performing exponential moving averaging or stochastic weighted averaging on the training dataset. Instructions to remove not-a-number errors can include reducing initial learning rate or adding gradient clipping.

The output data 104 can be sent for display on a user display, as an example. In some implementations, the proxy task design system 100 can be configured to provide the output data 104 as a set of computer-readable instructions, such as one or more computer programs. The computer programs can be written in any type of programming language, and according to any programming paradigm, e.g., declarative, procedural, assembly, object-oriented, data-oriented, functional, or imperative. The computer programs can be written to perform one or more different functions and to operate within a computing environment, e.g., on a physical device, virtual machine, or across multiple devices. The computer programs can also implement functionality described herein, for example, as performed by a system, engine, module, or model. The proxy task design system 100 can further be configured to forward the output data 104 to one or more other devices configured for translating the output data 104 into an executable program written in a computer programming language and optionally as part of a framework for generating a proxy task. The proxy task design system 100 can also be configured to send the output data 104 to a storage device for storage and later retrieval.

The proxy task design system 100 can include a variance measurement engine 106. The variance measurement engine 106 can be implemented as one or more computer programs, specially configured electronic circuitry, or any combination of the preceding. The variance measurement engine 106 can be configured to measure variance for one or more metrics for a trainer. When a proxy task is repeated multiple times for the same model without any changes, variance in the one or more metrics, e.g., accuracy or latency, should be small. The variance measurement engine 106 can measure variance over reported scores over multiple runs using a standard deviation based measure, such as coefficient of variation. Large variance during training can be mitigated using cosine decay or stepwise learning rate decay as a learning-rate schedule rather than a constant learning rate. Exponential moving average or stochastic weighted averaging can further increase smoothness to decrease variance.

The variance measurement engine 106 can modify baseline training configurations to reduce training steps to run for a short period of time, e.g., 1-2 hours, and use a cosine decay learning rate with its steps set so that the learning rate can approach zero towards the end of the training. The variance measurement engine 106 can sample a search space to find a model that would not generate any errors, such as out-of-memory (OOM) and/or learning rate errors like not-a-number (NAN). The variance measurement engine 106 can run a sampled model for one or more training steps. If the sampled model runs for the one or more training steps without generating any errors, then the variance measurement engine 106 can select that model. Once the model is found, the variance measurement engine 106 can generate copies of the model, e.g., 5 copies, and run the copies for the reduced training steps. The variance measurement engine 106 can measure a variance score and/or smoothness score once training is complete. If the variance and/or smoothness is too high, e.g., the scores are above thresholds, the variance measurement engine 106 can output instructions with suggestions to lower the variance, such as utilizing exponential moving average or stochastic weighted averaging.

The variance measurement engine 106 can be further configured to remove OOM and/or learning rate related errors. Proxy task search spaces can generate models significantly larger than a baseline model, even when batch size is tuned for the baseline model. The variance measurement engine 106 can be configured to output instructions with suggestions to reduce batch size if an OOM error occurs. The variance measurement engine 106 can also be configured to output instructions with suggestions to reduce initial learning rate or add gradient clipping if a learning rate related error occurs.

The proxy task design system 100 can further include a correlation model selection engine 108. The correlation model selection engine 108 can be implemented as one or more computer programs, specially configured electronic circuitry, or any combination of the preceding. The correlation model selection engine 108 can be configured to select candidate correlation models to compute correlation score of proxy tasks. A quality proxy task can have a correlation between proxy task training and full training. If one model performs better than another model during proxy task training, then the model that performed better can likely perform better during full training as well. To validate this assumption, the correlation model selection engine 108 can rank correlation between proxy task training scores and full training score using correlation candidate models. Proxy tasks can be ranked using correlation scores for the one or more metrics.

The correlation model selection engine 108 can be configured to find a number of correlation candidate models, such as about 10-20, and compute their full-training scores to act as a reference for computing proxy task correlation scores for different proxy task choices. The correlation model selection engine 108 can ensure the correlation candidate models have a sufficient score distribution for the one or more metrics, such as accuracy, latency, memory usage, and/or power consumption. A sufficient score distribution can correspond to correlation candidate models having scores with enough variation to rank correlation. For example, if the models in the search space each have a score varying in the range of [0.2, 0.8], then the correlation candidate models can have a range of at least 60-70% or above that range. The sampling in the range should also be spread-out. For example, instead of 8 out of 10 models with a score of 0.2 and 2 models with score of 0.8, ideally the 10 candidate models should have a score of [0.2, 0.26, 0.32, 0.38, 0.44, 0.5, 0.56, 0.62, 0.68, 0.74]. A bad distribution would be [0.2, 0.2, 0.2, 0.2, 0.8] as the repeated scores add no new information.

The correlation model selection engine 108 can be configured to randomly sample a plurality of models, such as 50, from a search space and train them for a fraction of the full training time, such as 1/50 of the full training time. As an example, the fraction of the full training time can be related to the amount of randomly sampled models, e.g., the fraction can be 1/[the number of models]. The correlation model selection engine 108 can reject a first portion of the plurality of models which do not add more to the distribution of the metrics. For example, the correlation model selection engine 108 can reject models that repeat scores for the metrics. The correlation model selection engine 108 can then be configured to train the remaining models for another fraction of the full training time, though this training time can be longer than the initial fraction of the full training time, and reject a second portion of the plurality of models which do not add more to the distribution of the metrics. The correlation model selection engine 108 can be configured to repeat the training and rejection until a minimum number of models remain, e.g., 10-15 models, and/or a sufficient score distribution is achieved, e.g., no more than 2 duplicate scores in the distribution.

The proxy task design system 100 can also include a proxy task selection engine 110. The correlation model selection engine 110 can be implemented as one or more computer programs, specially configured electronic circuitry, or any combination of the preceding. The proxy task selection engine 110 can be configured to search for a proxy task choice, such as an optimal proxy task choice. The optimal proxy task choice can be a proxy task choice from a proxy task search space that has the lowest neural architecture search cost while meeting a minimum correlation requirement threshold. The optimal proxy task choices can save computing resources, such as memory usage or processing power, by optimally reducing the cost of a neural architecture search. As an example, the proxy task search space can be defined by discrete dimensions for training data and model scale. The proxy task selection engine 110 can determine an optimal training step based on proxy task choices for training data and model scale. As such, training step dimensions may or may not be included in the search space.

The proxy task selection engine 110 can initially set the number of training steps as the same amount as full baseline training. When evaluating a proxy task choice, the proxy task selection engine 110 can launch training for the correlation candidate models, monitor their score for the one or more metrics, e.g., accuracy and/or latency, and continuously compute a rank-correlation score using past full training scores for the correlation candidate models. The proxy task selection engine 110 can stop the training for the correlation candidate models once a correlation threshold is obtained, such as 0.7, or a search cost quota is exceeded, such as greater than 4 hours per task. The proxy task selection engine 110 can evaluate each proxy task choice from the search space, such as via a grid search, and output the optimal choice. Each proxy task evaluation can include additional data, such as progress of accuracy correlation, p-values, median accuracy, and median training time over training steps. Each proxy task evaluation can also include a reason for stopping a search, such as training time limit exceeded, and the training step at which it stops. The proxy task selection engine 110 can set the number of training steps and the number of cosine decay steps to the number of training steps of the optimal proxy task. The proxy task selection engine 110 can also perform a validation score evaluation at the end of the training, to save multiple evaluation costs.

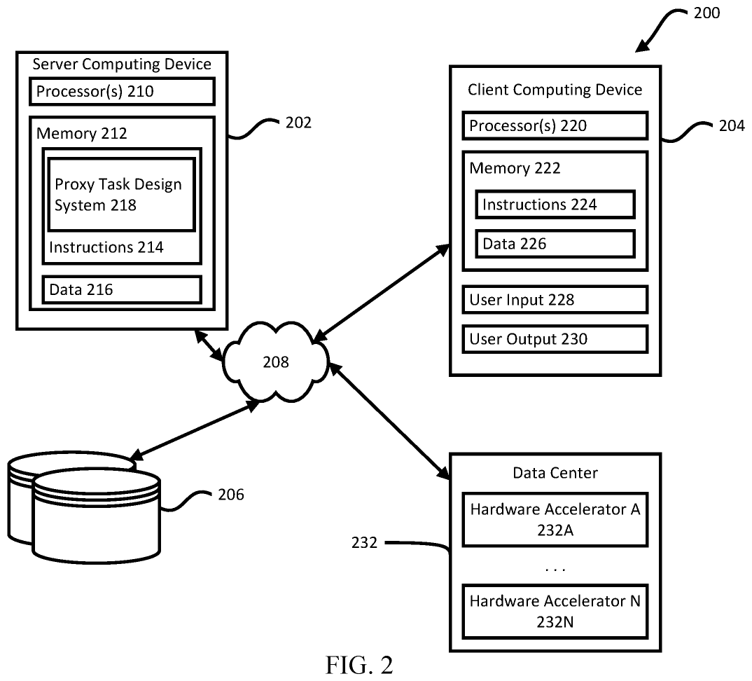

FIG. 2 depicts a block diagram of an example environment 200 for implementing a proxy task design system 218. The proxy task design system 218 can be implemented on one or more devices having one or more processors in one or more locations, such as in server computing device 202. Client computing device 204 and the server computing device 202 can be communicatively coupled to one or more storage devices 206 over a network 208. The storage devices 206 can be a combination of volatile and non-volatile memory and can be at the same or different physical locations than the computing devices 202, 204. For example, the storage devices 206 can include any type of non-transitory computer readable medium capable of storing information, such as a hard-drive, solid state drive, tape drive, optical storage, memory card, ROM, RAM, DVD, CD-ROM, write-capable, and read-only memories.

The server computing device 202 can include one or more processors 210 and memory 212. The memory 212 can store information accessible by the processors 210, including instructions 214 that can be executed by the processors 210. The memory 212 can also include data 216 that can be retrieved, manipulated, or stored by the processors 210. The memory 212 can be a type of non-transitory computer readable medium capable of storing information accessible by the processors 210, such as volatile and non-volatile memory. The processors 210 can include one or more central processing units (CPUs), graphic processing units (GPUs), field-programmable gate arrays (FPGAs), and/or application-specific integrated circuits (ASICs), such as tensor processing units (TPUs).

The instructions 214 can include one or more instructions that, when executed by the processors 210, cause the one or more processors to perform actions defined by the instructions 214. The instructions 214 can be stored in object code format for direct processing by the processors 210, or in other formats including interpretable scripts or collections of independent source code modules that are interpreted on demand or compiled in advance. The instructions 214 can include instructions for implementing a proxy task design system 218, which can correspond to the proxy task design system 100 of FIG. 1. The proxy task design system 218 can be executed using the processors 210, and/or using other processors remotely located from the server computing device 202.

The data 216 can be retrieved, stored, or modified by the processors 210 in accordance with the instructions 214. The data 216 can be stored in computer registers, in a relational or non-relational database as a table having a plurality of different fields and records, or as JSON, YAML, proto, or XML documents. The data 216 can also be formatted in a computer-readable format such as, but not limited to, binary values, ASCII, or Unicode. Moreover, the data 216 can include information sufficient to identify relevant information, such as numbers, descriptive text, proprietary codes, pointers, references to data stored in other memories, including other network locations, or information that is used by a function to calculate relevant data.

The client computing device 204 can also be configured similarly to the server computing device 202, with one or more processors 220, memory 222, instructions 224, and data 226. The client computing device 204 can also include a user input 228 and a user output 230. The user input 228 can include any appropriate mechanism or technique for receiving input from a user, such as keyboard, mouse, mechanical actuators, soft actuators, touchscreens, microphones, and sensors.

The server computing device 202 can be configured to transmit data to the client computing device 204, and the client computing device 204 can be configured to display at least a portion of the received data on a display implemented as part of the user output 230. The user output 230 can also be used for displaying an interface between the client computing device 204 and the server computing device 202. The user output 230 can alternatively or additionally include one or more speakers, transducers or other audio outputs, a haptic interface or other tactile feedback that provides non-visual and non-audible information to the platform user of the client computing device 204.

Although FIG. 2 illustrates the processors 210, 220 and the memories 212, 222 as being within the computing devices 202, 204, components described herein can include multiple processors and memories that can operate in different physical locations and not within the same computing device. For example, some of the instructions 214, 224 and the data 216, 226 can be stored on a removable SD card and others within a read-only computer chip. Some or all of the instructions and data can be stored in a location physically remote from, yet still accessible by, the processors 210, 220. Similarly, the processors 210, 220 can include a collection of processors that can perform concurrent and/or sequential operation. The computing devices 202, 204 can each include one or more internal clocks providing timing information, which can be used for time measurement for operations and programs run by the computing devices 202, 204.

The server computing device 202 can be connected over the network 208 to a data center 232 housing any number of hardware accelerators 232A-N. The data center 232 can be one of multiple data centers or other facilities in which various types of computing devices, such as hardware accelerators, are located. Computing resources housed in the data center 232 can be specified for deploying models related to proxy tasks of neural architecture searches as described herein.

The server computing device 202 can be configured to receive requests to process data from the client computing device 204 on computing resources in the data center 232. For example, the environment 200 can be part of a computing platform configured to provide a variety of services to users, through various user interfaces and/or application programming interfaces (APIs) exposing the platform services. The variety of services can include generating one or more proxy tasks for a neural architecture search. The client computing device 204 can transmit input data associated with proxy task choices and metrics for evaluating the proxy task choices. The proxy task design system 218 can receive the input data, and in response, generate output data including a selected proxy task, such as an optimal proxy task.

As other examples of potential services provided by a platform implementing the environment 200, the server computing device 202 can maintain a variety of models in accordance with different constraints available at the data center 232. For example, the server computing device 202 can maintain different families for deploying models on various types of TPUs and/or GPUs housed in the data center 232 or otherwise available for processing.

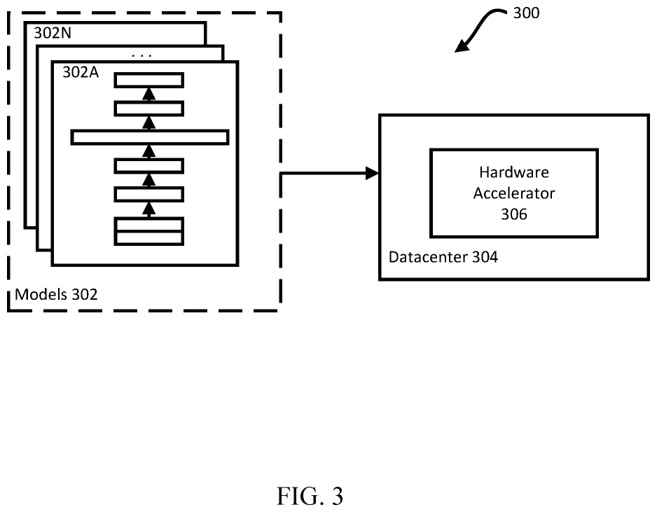

FIG. 3 depicts a block diagram 300 illustrating one or more model architectures 302, more specifically 302A-N for each architecture, for deployment in a data center 304 housing a hardware accelerator 306 on which the deployed models 302 will execute for providing proxy tasks for a neural architecture search. The hardware accelerator 306 can be any type of processor, such as a CPU, GPU, FPGA, or ASIC such as a TPU.

An architecture 302 of a model can refer to characteristics defining the model, such as characteristics of layers for the model, how the layers process input, or how the layers interact with one another. For example, the model can be a convolutional neural network (ConvNet) that includes a convolution layer that receives input data, followed by a pooling layer, followed by a fully connected layer that generates a result. The architecture 302 of the model can also define types of operations performed within each layer. For example, the architecture of a ConvNet may define that rectified linear unit (ReLU) activation functions are used in the fully connected layer of the network. One or more model architectures 302 can be generated that can output results associated with proxy task choices for a neural architecture search.

Referring back to FIG. 2, the devices 202, 204 and the data center 232 can be capable of direct and indirect communication over the network 208. For example, using a network socket, the client computing device 204 can connect to a service operating in the data center 232 through an Internet protocol. The devices 202, 204 can set up listening sockets that may accept an initiating connection for sending and receiving information. The network 208 itself can include various configurations and protocols including the Internet, World Wide Web, intranets, virtual private networks, wide area networks, local networks, and private networks using communication protocols proprietary to one or more companies. The network 208 can support a variety of short- and long-range connections. The short- and long-range connections may be made over different bandwidths, such as 2.402 GHz to 2.480 GHZ, commonly associated with the Bluetooth® standard, 2.4 GHz and 5 GHz, commonly associated with the Wi-Fi® communication protocol; or with a variety of communication standards, such as the LTE® standard for wireless broadband communication. The network 208, in addition or alternatively, can also support wired connections between the devices 202, 204 and the data center 232, including over various types of Ethernet connection.

Although a single server computing device 202, client computing device 204, and data center 232 are shown in FIG. 2, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device connected to hardware accelerators configured for processing optimization models, and any combination thereof.

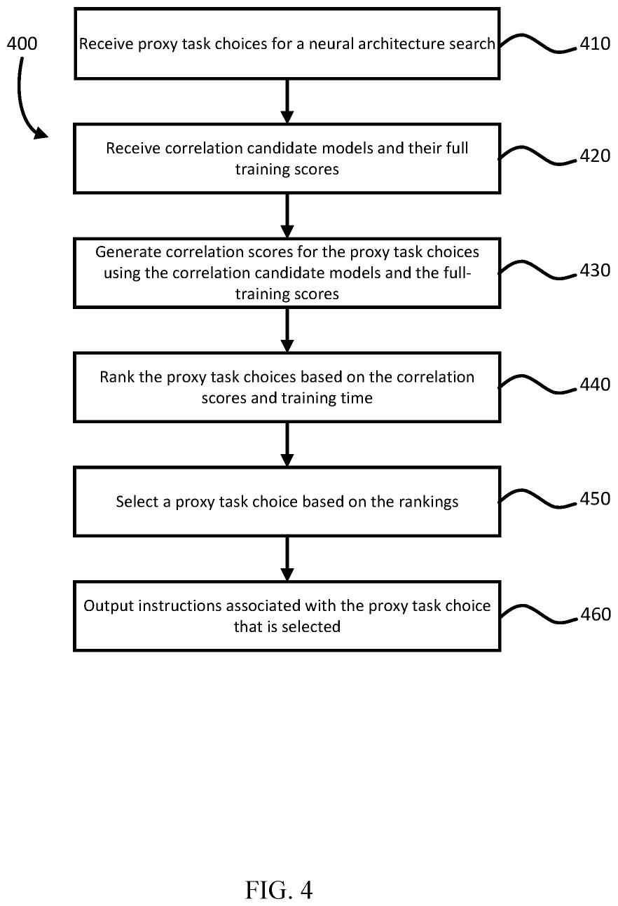

FIG. 4 depicts a flow diagram of an example process 400 for determining a proxy task for a neural architecture search. The example process 400 can be performed on a system of one or more processors in one or more locations, such as the proxy task design system 100 of FIG. 1.

As shown in block 410, the proxy task design system 100 can receive proxy task choices for a neural architecture search. The proxy task choices can include training step reduction, training dataset sub-sampling, and/or model scale down. Training step reduction can include reducing the number of training steps for a trainer and reporting a score back based on a partial training with the reduced number of training steps. Training dataset sub-sampling can correspond to randomly shuffling data and selecting a percentage of the full training dataset based on the random shuffling. Model scale down can correspond to reducing model architecture relative to a baseline model, such as reducing model width, reducing model depth, and/or reducing training data size without eliminating features. Model scale down can further include tightening constraints, such as latency, memory usage, and/or power consumption. Model scale down can also include reducing an amount of augmentation and regularization compared to a baseline model.

The proxy task design system 100 can also receive one or more metrics for selecting models and/or evaluating proxy task choices. The one or more metrics can correspond to performance for the model, such as accuracy and/or constraints for the model, such as latency, memory usage, and/or power consumption.

As shown in block 420, the correlation model selection engine 108 can receive correlation candidate models and their full training scores. The correlation model selection engine 108 can determine correlation candidate models to evaluate the proxy task choices. A quality proxy task can have a correlation between proxy task training and full training. The correlation model selection engine 108 can select correlation candidate models that have a sufficient score distribution for the one or more metrics, such as accuracy, latency, memory usage, and/or power consumption.

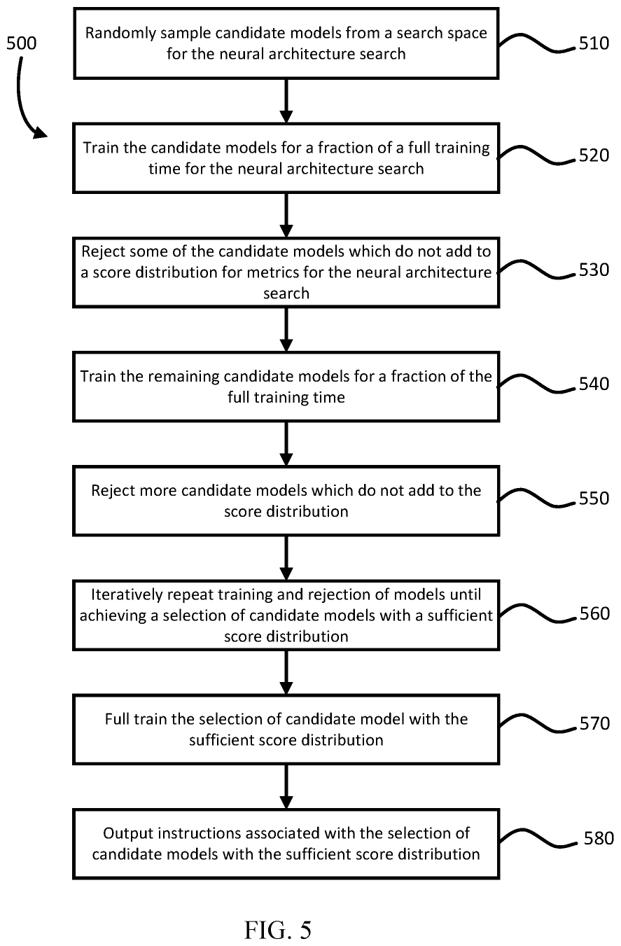

FIG. 5 depicts a flow diagram of an example process 500 for determining correlation candidate models to evaluate proxy task choices. The example process 500 can be performed on a system of one or more processors in one or more locations, such as the proxy task design system 100 of FIG. 1.

As shown in block 510, the correlation model selection engine 108 can randomly sample candidate models from a search space for the neural architecture search. For example, the correlation model selection engine 108 can sample 50 models from the search space.

As shown in block 520, the correlation model selection engine 108 can train the candidate models for a period of time that is a fraction of the full training time for the neural architecture search. For example, the correlation model selection engine 108 can train the candidate models for 1/50^{th} of the full training time. The fraction of the full training time can be related to the amount of randomly sampled models.

As shown in block 530, the correlation model selection engine 108 can reject some of the candidate models which do not add to the score distribution for the one or more metrics. For example, the correlation model selection engine 108 can remove candidate models having redundant scores for the one or more metrics. For instance, the correlation model selection engine 108 can remove 5 models if those models have similar scores to other models.

As shown in block 540, the correlation model selection engine 108 can train the remaining candidate models for a period of time that is a fraction of the full training time for the neural architecture search. This training time can be longer than the initial fraction of the full training time and can also be related to the amount of remaining candidate models. For example, if the correlation model selection engine 108 removed 5 models, the remaining candidate model amount can be 45. The correlation model selection engine 108 can train these models for 1/45^{th} of the full training time.

As shown in block 550, the correlation model selection engine 108 can reject more of the candidate models which do not add to the score distribution for the one or more metrics. For example, the correlation model selection engine 108 can remove candidate models having redundant, repeat, and/or similar scores for the one or more metrics. For instance, the correlation model selection engine 108 can remove another 5 models if those models have similar scores to other models. The amount of models removed could be the same or different from the prior rejection, depending on which models produce similar scores.

As shown in block 560, the correlation model selection engine 108 can iteratively repeat the training and rejection of candidate models until achieving a selection of candidate models with a sufficient score distribution. The sufficient score distribution can have a threshold amount of variation such that correlation can be ranked. The sufficient score distribution can also minimize redundancies or similarities in scores from the models. For example, the amount of candidate correlation models to achieve a sufficient score distribution can be about 10-20.

As shown in block 570, the correlation model selection engine 108 can generate full-training scores for the selected correlation candidate models. The correlation model selection engine 108 can train the correlation candidate models for their full training time to compute their full training scores. The full training scores can act as a reference for computing proxy task correlation scores for different proxy tasks.

As shown in block 580, the correlation model selection engine 108 can output the selection of candidate models with the sufficient score distribution. For example, the correlation model selection engine 108 can output instructions associated with the selection.

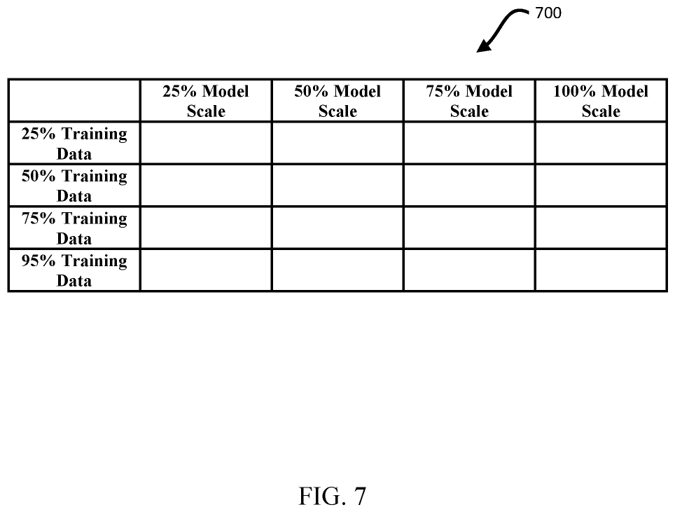

Referring back to FIG. 4, as shown in block 430, the proxy task selection engine 110 can generate correlation scores for the received proxy task choices using the correlation candidate models and the generated full training scores. As an example, depicted in FIG. 7, a proxy task search space 700 can be defined by discrete dimensions for training data and model scale. The proxy task selection engine 110 can monitor scores for the one or more metrics during training of the correlation candidate models and continuously compute a rank-correlation score using past full training scores for the correlation candidate models. The proxy task selection engine 110 can stop training the correlation candidate models once a correlation threshold is obtained, e.g., 0.6-0.8, or a search cost quota is exceeded, such as greater than 3-5 hours per task.

As shown in block 440, the proxy task selection engine 110 can rank proxy task choices based on the correlation scores and training time, such as via a grid search. Proxy task choices that achieved a minimum correlation threshold within a search cost quota can be ranked higher than proxy task choices where the search cost quota was exceeded. Further, proxy task choices that achieved the minimum correlation threshold within shorter periods of time can be ranked higher than proxy task choices that achieved the minimum correlation threshold within a longer period of time, even if the proxy task choice results in a higher correlation score.

As shown in block 450, the proxy task selection engine 110 can select a proxy task choice based on the rankings. For example, the proxy task selection engine 110 can select an optimal proxy task choice, which can correspond to a proxy task choice with the lowest neural architecture search cost while meeting a minimum correlation requirement threshold. The optimal proxy task choices can save computing resources, such as memory usage or processing power, by optimally reducing the cost of a neural architecture search.

As shown in block 460, the proxy task selection engine 110 can output instructions associated with the proxy task choice that is selected. The proxy task selection engine 110 can output the optimal proxy task choice. The proxy task selection engine 110 can also output each proxy task evaluation, which can include data such as accuracy correlation, p-values, median accuracy, and median training time over training steps. Each proxy task evaluation can also include a reason for stopping a search, such as training time limit exceeded or threshold correlation reached, and the training step at which it stops. The proxy task selection engine 110 can output instructions for setting the number of training steps and the number of cosine decay steps to the number of training steps of the optimal proxy task.

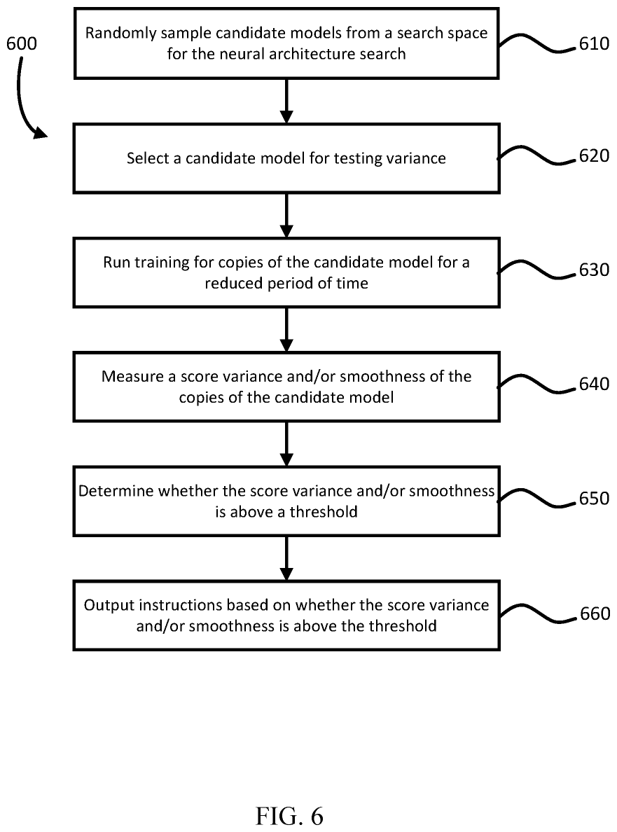

FIG. 6 depicts a flow diagram of an example process 600 for determining variance in evaluating proxy task choices. The example process 600 can be performed on a system of one or more processors in one or more locations, such as the proxy task design system 100 of FIG. 1.

As shown in block 610, the variance measurement engine 106 can randomly sample candidate models from a search space for the neural architecture search.

As shown in block 620, the variance measurement engine 106 can select a candidate model for testing variance. The candidate model can correspond to a model that does not generate any errors.

As shown in block 630, the variance measurement engine 106 can generate copies of the selected model and run training for copies of the selected model for a reduced period of the full training time. For example, the variance measurement engine 106 can train 5 copies of the selected model for about 1-2 hours each. Further, the variance measurement engine 106 can use a cosine decay learning rate with its steps set so that the learning rate can approach zero towards the end of the training.

As shown in block 640, the variance measurement engine 106 can measure a score variance and/or score smoothness of the copies of the selected model. The variance measurement engine 106 can measure variance using a standard deviation based measure, such as coefficient of variation.

As shown in block 640, the variance measurement engine 106 can determine whether the score variance and/or score smoothness is above a threshold, such as 0.4 for coefficient of variation.

As shown in block 650, the variance measurement engine 106 can output instructions based on whether the score variance and/or score smoothness is above the threshold. If the score variance and/or score smoothness is above the threshold, then the variance is too high so the variance measurement engine 106 can output instructions for lowering the variance. For example, the variance measurement engine 106 can suggest as utilizing exponential moving average or stochastic weighted averaging. If the score variance and/or score smooth is below or equal to the threshold, then the variance measurement engine 106 can output instructions to proceed with evaluating the proxy design choices.

As such, generally disclosed herein are implementations for design tools to automatically find proxy tasks for neural architecture searches, such as finding an optimal proxy task.

Aspects of this disclosure can be implemented in digital circuits, computer-readable storage media, as one or more computer programs, or a combination of one or more of the foregoing. The computer-readable storage media can be non-transitory, e.g., as one or more instructions executable by a cloud computing platform and stored on a tangible storage device.

The phrase “configured to” is used in different contexts related to computer systems, hardware, or part of a computer program. When a system is said to be configured to perform one or more operations, this means that the system has appropriate software, firmware, and/or hardware installed on the system that, when in operation, causes the system to perform the one or more operations. When some hardware is said to be configured to perform one or more operations, this means that the hardware includes one or more circuits that, when in operation, receive input and generate output according to the input and corresponding to the one or more operations. When a computer program is said to be configured to perform one or more operations, this means that the computer program includes one or more program instructions, that when executed by one or more computers, causes the one or more computers to perform the one or more operations.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method for automatically determining a proxy task for a neural architecture search, comprising:
determining, by one or more processors, a plurality of correlation candidate models to evaluate each of a plurality of proxy task choices for the neural architecture search;
generating, by the one or more processors, full-training scores for each of the plurality of correlation candidate models;
generating, by the one or more processors, a correlation score for each of the plurality of proxy task choices using the plurality of correlation candidate models and the full-training scores;
ranking, by the one or more processors, the plurality of proxy task choices based on the correlation scores and training time;
selecting, by the one or more processors, a proxy task choice of the plurality of proxy task choices based on the ranking; and
outputting, by the one or more processors, instructions associated with the selected proxy task choice.

2. The method of claim 1, further comprising receiving, by the one or more processors, the plurality of proxy task choices for the neural architecture search.

3. The method of claim 1, wherein determining the plurality of correlation candidate models further comprises:
randomly sampling a first plurality of models from a search space for the neural architecture search;
training each of the first plurality of models for a first fraction of a full training time for the neural architecture search; and
rejecting a first portion of the first plurality of models which do not add to a score distribution for one or more metrics among the first plurality of models, wherein a second plurality of models corresponds to the first portion subtracted from the first plurality of models.

4. The method of claim 3, wherein determining the plurality of correlation candidate models further comprises:
training each of the second plurality of models for a second fraction of the full training time for the neural architecture search, the second fraction being greater than the first fraction; and
rejecting a second portion of the second plurality of models which do not add to a score distribution for the one or more metrics among the second plurality of models.

5. The method of claim 4, wherein determining the plurality of correlation candidate models further comprises iteratively repeating training and rejecting of models until meeting a minimum amount of candidate models.

6. The method of claim 1, wherein generating the correlation scores for each of the plurality of proxy task choices further comprises:
training each of the plurality of correlation candidate models; and
during the training:
monitoring one or more metrics and training time; and
continuously computing the correlation score based on the full-training scores.

7. The method of claim 6, wherein generating the correlation scores for each of the plurality of proxy task choices further comprises stopping the training once a threshold correlation score is obtained or at least one of a threshold amount of time or a threshold for the one or more metrics is exceeded.

8. The method of claim 7, wherein selecting the proxy task choice of the plurality of proxy tasks further comprises selecting a proxy task choice that obtained the threshold correlation score within the shortest amount of time.

9. The method of claim 1, further comprising:
randomly sampling, by the one or more processors, the search space to find a model for testing variance;
running, by the one or more processors, training for a plurality of copies of the model for a reduced period of time; and
measuring, by the one or more processors, at least one of a score variance or smoothness of the plurality of copies of the model.

10. The method of claim 9, further comprising:
determining, by the one or more processors, the score variance or smoothness is above a threshold; and
outputting one or more instructions to lower the variance.

11. A system comprising:
one or more processors; and
one or more storage devices coupled to the one or more processors and storing instructions that, when executed by the one or more processors, cause the one or more processors to perform operations for automatically determining a proxy task for a neural architecture search, the operations comprising:
determining a plurality of correlation candidate models to evaluate each of a plurality of proxy task choices for the neural architecture search;
generating full-training scores for each of the plurality of correlation candidate models;
generating a correlation score for each of the plurality of proxy task choices using the plurality of correlation candidate models and the full-training scores;
ranking the plurality of proxy task choices based on the correlation scores and training time;
selecting a proxy task choice of the plurality of proxy task choices based on the ranking; and
outputting instructions associated with the selected proxy task choice.

12. The system of claim 11, wherein determining the plurality of correlation candidate models further comprises:
randomly sampling a first plurality of models from a search space for the neural architecture search;
training each of the first plurality of models for a first fraction of a full training time for the neural architecture search; and
rejecting a first portion of the first plurality of models which do not add to a score distribution for one or more metrics among the first plurality of models, wherein a second plurality of models corresponds to the first portion subtracted from the first plurality of models.

13. The system of claim 12, wherein determining the plurality of correlation candidate models further comprises iteratively repeating training and rejecting of models until meeting a minimum amount of candidate models.

14. The system of claim 11, wherein generating the correlation scores for each of the plurality of proxy task choices further comprises:
training each of the plurality of correlation candidate models;
during the training:
monitoring one or more metrics and training time; and
continuously computing the correlation score based on the full-training scores; and
stopping the training once a threshold correlation score is obtained or at least one of a threshold amount of time or a threshold for the one or more metrics is exceeded.

15. The system of claim 14, wherein selecting the proxy task choice of the plurality of proxy tasks further comprises selecting a proxy task choice that obtained the threshold correlation score within the shortest amount of time.

16. The system of claim 11, wherein the operations further comprise:
randomly sampling the search space to find a model for testing variance;
running training for a plurality of copies of the model for a reduced period of time; and
measuring at least one of a score variance or smoothness of the plurality of copies of the model.

17. A non-transitory computer readable medium for storing instructions that, when executed by one or more processors, cause the one or more processors to perform operations for automatically determining a proxy task for a neural architecture search, the operations comprising:
determining a plurality of correlation candidate models to evaluate each of a plurality of proxy task choices for the neural architecture search;
generating full-training scores for each of the plurality of correlation candidate models;
generating a correlation score for each of the plurality of proxy task choices using the plurality of correlation candidate models and the full-training scores;
ranking the plurality of proxy task choices based on the correlation scores and training time;
selecting a proxy task choice of the plurality of proxy task choices based on the ranking; and
outputting instructions associated with the selected proxy task choice.

18. The non-transitory computer readable medium of claim 17, wherein determining the plurality of correlation candidate models further comprises:
randomly sampling a first plurality of models from a search space for the neural architecture search;
training each of the first plurality of models for a first fraction of a full training time for the neural architecture search;
rejecting a first portion of the first plurality of models which do not add to a score distribution for one or more metrics among the first plurality of models, wherein a second plurality of models corresponds to the first portion subtracted from the first plurality of models; and
iteratively repeating training and rejecting of models until meeting a minimum amount of candidate models.

19. The non-transitory computer readable medium of claim 17, wherein generating the correlation scores for each of the plurality of proxy task choices further comprises:
training each of the plurality of correlation candidate models;
during the training:
monitoring one or more metrics and training time; and
continuously computing the correlation score based on the full-training scores; and
stopping the training once a threshold correlation score is obtained or at least one of a threshold amount of time or a threshold for the one or more metrics is exceeded.

20. The non-transitory computer readable medium of claim 17, wherein the operations further comprise:
randomly sampling the search space to find a model for testing variance;
running training for a plurality of copies of the model for a reduced period of time; and
measuring at least one of a score variance or smoothness of the plurality of copies of the model.
